(19) United States
(12) Patent Application Publication
(10) Pub. No.: US 2012/0100917 A1
(43) Pub. Date: Apr. 26, 2012

(54) VIDEO GAME ACTION DETECTING SYSTEM

(76) Inventor: WAI LAM YUNG, HONG KONG (HK)

(21) Appl. No.: 13/038,375

(22) Filed: Mar. 1, 2011

(30) Foreign Application Priority Data
Oct. 22, 2010 (CN) 201010516393.3

(51) Int. Cl. A63F 13/06

(52) U.S. Cl. 463/39

(57) ABSTRACT

The invention relates to video game technology, and more particularly is a video game detecting system. It includes a main console module, remote controller module, and a main console/remote control module communication link. The remote control module will react to the message from the main console module. The remote control module consists of a microcontroller unit (MCU) and gripping force detector (grip sensor). The gripping force detector is connected to the MCU, and can detect the gripping force applied to the remote control module by the video game player. The remote control MCU will transmit the gripping force information to the main console module via RF wireless technology. Based on the game software design, the video game system will provide a feedback reaction based on the gripping force of the video game player.

### PRIORITY CLAIM

This application claims priority to Chinese Patent Application No. 201010516393.3, filed Oct. 22, 2010, the entire contents of which are expressly incorporated herein by reference.

### FIELD OF THE INVENTION

This invention relates to video games, and more particularly to a video game action detecting system.

### BACKGROUND OF THE INVENTION

The capabilities of video game consoles and personal computers have become more and more powerful with the continuous development of electronics technology. There are many new video games in the market, and the video and audio in these games is becoming more and more sophisticated. At the same time, the virtual reality demands from the players of these video games in these areas becomes higher and higher.

There are direction pad keys (D-Pad keys) on video game remote controllers in the current market. The user controls the video game with the D-Pad keys. Typically, the video game remote control is connected to the video game main console, with the user use the D-pad for controlling the game operation. This method of operation is not so convenient to the player. Moreover, recent improvements toward the player's experience have been mainly in the video and audio areas. There has not been corresponding improvement in the user experience in the virtual reality.

The China new invention patent (Patent number: 200780027212.7), the contents of which are expressly incorporated herein by reference, disclosed a video game remote control and video game detecting system which include a motion sensor to detect the motion of the player, a position detector to detect the position of the player, and combines the signals from these two detectors to detect the movement of the video game player. The system can also detect the gripping force of the player.

### SUMMARY OF THE INVENTION

This invention uses an analog switch to detect the gripping force of the player. The gripping force information is transmitted to the video game main console via wireless technology. Based on the game software design, the game will provide feedback according to the gripping force.

This invention is a video game action detecting system. It includes the video game main console module and the video game remote control module. The main console module receives messages from the remote control module. The remote control module consists of a microcontroller unit (MCU) and gripping force detector. The gripping force detector is connected to the MCU of the remote control module. The gripping force detector detects the gripping force of the player. The remote control module transmits the gripping force information to the main console module.

The main console module is connected with the remote control module by wireless technology. There are wireless communication modules inside the main console module and the remote control module.

The gripping force detector includes: port 1, port 2, port 3, port 4, port 5, port 6, port 7, port 8, port 9, and port 10. The remote control module MCU pin 20, pin 21, pin 22, pin 23, and pin 24 are connected to port 1, port 3, port 5, port 7, and port 9 respectively. The port 2, port 4, port 6, port 8, and port 10 of the gripping force detectors are connected to the pin 35 of the MCU of the remote control module.

The pin 34 of the remote control module MCU is connected to the pin 3 of the wireless communication module.

The pin 47 of the remote control module MCU is connected to the pin 4 of the wireless communication module.

The pin 33 of the remote control module MCU is connected to the pin 5 of the wireless communication module.

The pin 30 of the remote control module MCU is connected to the pin 6 of the wireless communication module.

The pin 12 of the remote control module MCU is connected to the pin 8 of the wireless communication module.

The gripping force detector port 1 is connected to one side of switch S1, one side of potentiometer W1, one side of resistor R10, one side of resistor R15, and one side of R16. The other side of switch S1, the other side of potentiometer W1, and the other side of resistor R10 are connected to the port 2 of the gripping force detector. The other side of resistor R15 and the other side of resistor R16 are connected to ground.

The gripping force detector port 3 is connected to one side of switch S2, one side of potentiometer W2, one side of resistor R11, one side of resistor R17, and one side of R18. The other side of switch S2, the other side of potentiometer W2, and the other side of resistor R11 are connected to the port 4 of the gripping force detector. The other side of resistor R17 and the other side of resistor R18 are connected to ground.

The gripping force detector port 6 is connected to one side of switch S3, one side of potentiometer W3, one side of resistor R12, one side of resistor R19, and one side of R20. The other side of switch S3, the other side of potentiometer W3, and the other side of resistor R12 are connected to the port 6 of the gripping force detector. The other side of resistor R19 and the other side of resistor R20 are connected to ground.

The gripping force detector port 7 is connected to one side of switch S4, one side of potentiometer W4, one side of resistor R13, one side of resistor R21, and one side of R22. The other side of switch S4, the other side of potentiometer W4, and the other side of resistor R13 are connected to the port 8 of the gripping force detector. The other side of resistor R21 and the other side of resistor R22 are connected to ground.

The gripping force detector port 9 is connected to one side of switch S5, one side of potentiometer W5, one side of resistor R14, one side of resistor R23, and one side of R24. The other side of switch S5, the other side of potentiometer W5, and the other side of resistor R14 are connected to the port 10 of the gripping force detector. The other side of resistor R23 and the other side of resistor R24 are connected to ground.

The wireless communication module is a 2.4 GHz RF module. The model number for the 2.4 GHz RF module is CB2100.

There is a position indicator module in the remote control module, and a position detector module in the main console module. The position indicator module emits a wide angle infrared ray to the position detector module to detect the position of the remote control module.

There is a motion sensor in the remote control module. The motion sensor is connected to the MCU of the remote control module. The motion sensor detects the motions of the game player. The MCU of the remote controller module transmits the motion information to the main console module. The main console module reacts to these motions.

There is a MCU in the main console module, and the video and audio players are connected to the MCU.

The model number for the remote control module MCU is STM8S105. The model number for the main console module MCU is CPL32300A.

The remote control module includes the voice sensor, LED indicator, and sound module. The voice sensor, LED indicator, and sound module are connected to the MCU of the remote control module.

The voice sensor is used to detect the sound. The remote control MCU will convert the sound from the player of the game into an electric signal and transmit it to the main console module.

The LED indicator is used to provide feedback in the video game and the connection status with the main console module.

The sound module is used to play back sound based on the main console module feedback.

The main console module may include a sub-MCU, with a connection between the main console MCU and sub-MCU, a connection between the position detector and sub-MCU, and a connection between the wireless transmission module and sub-MCU. The sub-MCU will carry out the pre-processing on the position detector signal and wireless communication module signal and then transfer the pre-processed information to the main console MCU.

The benefit of this invention: A video game action detecting system includes a main console module, a remote control module, and a main console module/remote control module communication link. The remote control module includes the remote control MCU and gripping force detector. The gripping force detector is connected to the remote control MCU. The gripping force detector detects the gripping force of the player of the video game. The remote control module transmits the gripping force information to the main console module. The main console module and remote control module are connected by wireless communication technology. There are wireless communication modules in the main console module and the remote control module. The remote control module transmits the gripping force information to the main console module. The main console module provides feedback according to the gripping force information and also controls the game.

This invention uses an analog switch to detect the gripping force, and uses wireless transmission technology to send the information from the remote control module to the main console module. Based on the design of the game software, there will be feedback according to the gripping force. This improves the virtual reality game experience and is convenient to use.

### BRIEF DESCRIPTION OF THE DRAWINGS

FIG. 1 is a block diagram for the main console module;

FIG. 2 is a block diagram for the remote control module;

FIG. 3 is a block diagram of the gripping force detector in the remote control module;

FIG. 4 is a schematic diagram for the remote control module without the sound chip circuit; and

FIG. 5 is a schematic diagram of the sound module circuit.

### DETAILED DESCRIPTION OF PREFERRED EMBODIMENTS

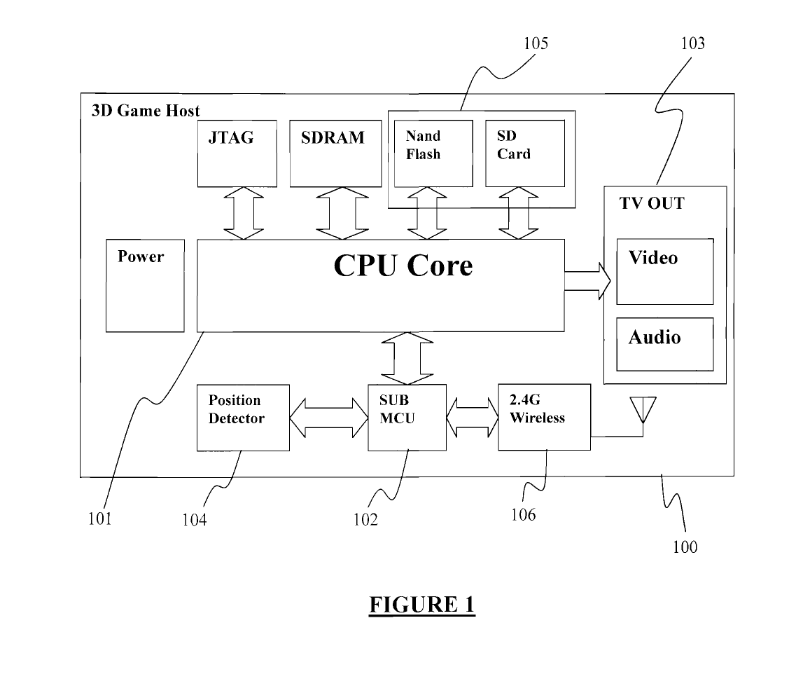

The attached FIGS. 1-5 depict embodiments of this invention. The following reference numbers are used herein:
100—Main console
101—Main console MCU
102—Main console Sub-MCU
103—Video/Audio player module
104—Position detector
105—Storage module (e.g., SD Card)
106—Main console wireless module
200—Remote control
201—Remote control MCU
202—Grip Sensor
203—Motion Sensor
204—Position indicator
205—Voice sensor
206—Sound Module
207—LED indicator
208—Remote control wireless module

An embodiment of the invention provides a video game action detecting system, including a main console module which receives messages from remote control module and provides feedback responsive to the messages. FIG. 1 depicts an embodiment of a main console module 100, which includes a main console MCU 101, an optional sub-MCU 102, a video/audio player module 103, a position detector 104, a storage module 105 (such as an SD card and/or Nand Flash), and a wireless interface 106 (such as a 2.4 GHz RF wireless module)

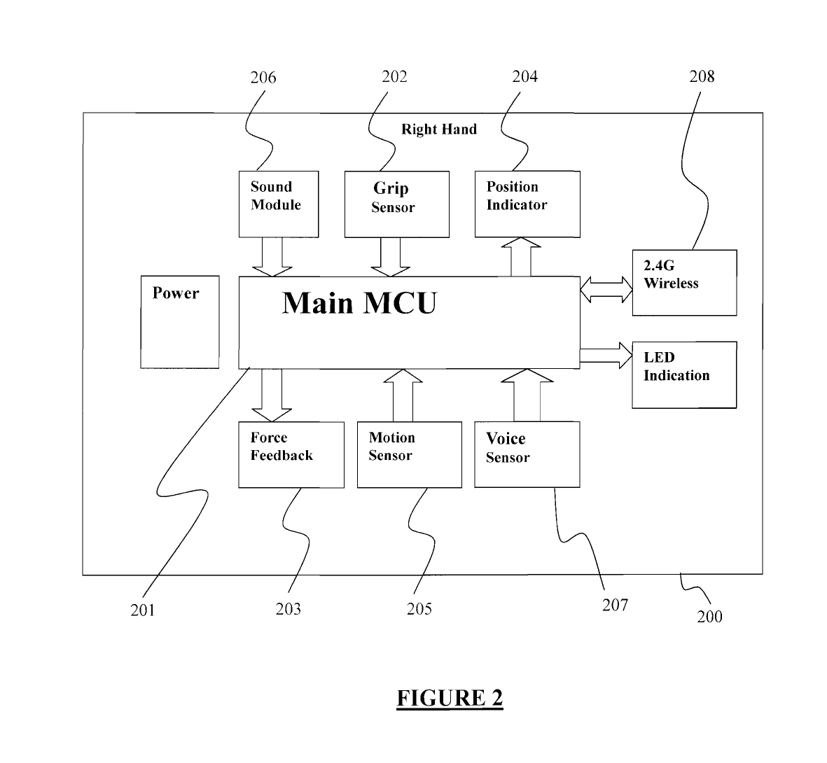

The remote control module 200, as depicted in FIG. 2, includes the remote control MCU 201 and gripping force detector (grip sensor) 202. The grip sensor 202 is connected to the remote control MCU 201. The grip sensor 202 detects the gripping force of the video game player. The MCU 201 transmits the gripping force information from the grip sensor 202 to the main console module 100 (depicted in FIG. 1).

The main console module 100 and remote control module 200 are connected using 2.4 GHz RF wireless technology. In an embodiment of the invention, the model number for the 2.4 GHz RF wireless module in the main console module and remote control module is CB21002.4G.

After the remote control MCU 201 transmits the gripping force message from the grip sensor 202 to the main console module 100, the main console module 100 will provide feedback based on the particular message and control the game operation.

An embodiment of the invention embodiment uses an analog switch to detect the gripping force, and uses 2.4 G RF wireless technology to transmit the information from the remote control module to the main console module. The video game will provide feedback based on the gripping force and the design of the game software. This enriches the user's experience in playing the game, and is easy to operate.

The embodiment of the remote control module in FIG. 2 includes a voice sensor 205, LED indicator 207, and sound module 206. The voice sensor 205, LED indicator 207, and sound module 26 are connected to the remote control MCU 201. The voice sensor 205 is used to detect the voice from the game player. The remote control MCU 201 will transmit the voice information from voice sensor 205 to the main console module 100. The LED indicator 207 is used to provide feedback reaction in the game, and can provide power on/off status and the wireless connection status. The sound module 206 is used to play back the feedback sound from the game.

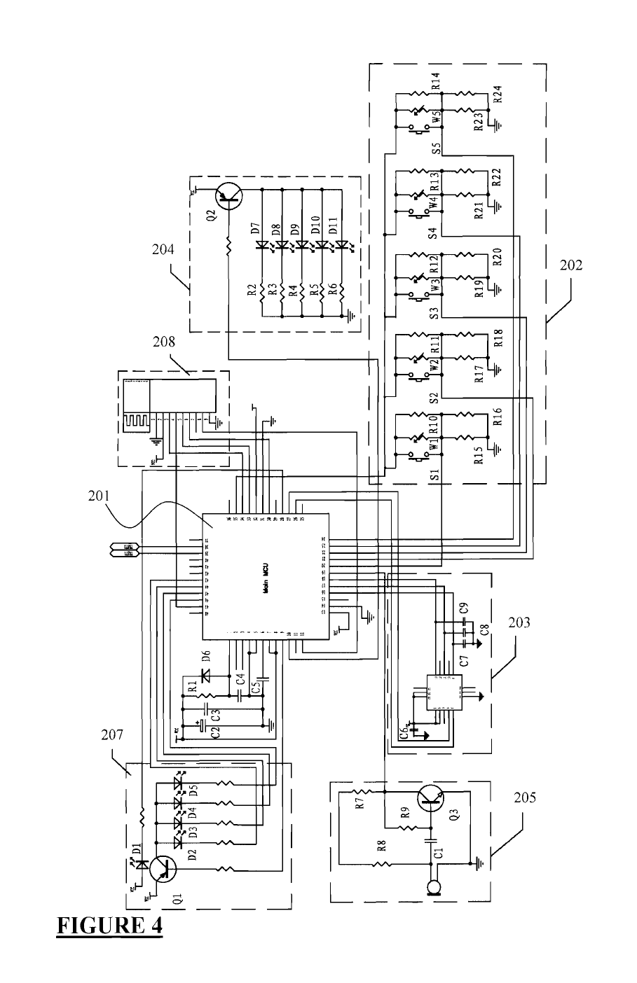

As depicted in FIG. 4, the grip sensor 202 includes port 1, port 2, port 3, port 4, port 5, port 6, port 7, port 8, port 9, and port 10. Pin 20, pin 21, pin 22, pin 23, and pin 24 of the remote control MCU 201 are connected to the port 1, port 3, port 5, port 7, and port 9 respectively. Port 2, port 4, port 6, port 8, and port 10 of grip sensor 202 are connected to the pin 35 of the remote control MCU 201. The pin 34 of remote control MCU 201 is connected to the pin 3 of the remote control wireless communication module 208. The pin 47 of the remote control MCU 201 is connected to the pin 4 of the wireless communication module 208. The pin 33 of remote control MCU 201 is connected to the pin 5 of the wireless communication module 208. The pin 30 of remote control MCU 201 is connected to the pin 6 of the wireless communication module 208. The pin 12 of remote control MCU 201 is connected to pin 8 of wireless communication module 208.

The port 1 of grip sensor 202 is connected to one side of switch S1, one side of potentiometer W1, one side of resistor R10, one side of resistor R15 and one side of resistor R16. The other side of switch S1, the other side of potentiometer W1, and the other side of resistor R10 are connected to the port 2 of grip sensor 202. The other side of resistor R15 and the other side of resistor R16 are connected to the ground.

The port 3 of grip sensor 202 is connected to one side of switch S2, one side of potentiometer W2, one side of resistor R11, one side of resistor R17, and one side of resistor R18. The other side of switch S2, the other side of potentiometer W2, and the other side of resistor R11 are connected to the port 4 of grip sensor 202. The other side of resistor R17 and the other side of resistor R18 are connected to the ground.

The port 5 of grip sensor 202 is connected to one side of switch S3, one side of potentiometer W3, one side of resistor R12, one side of resistor R19 and one side of resistor R20. The other side of switch S3, the other side of potentiometer W4, and the other side of resistor R12 are connected to the port 6 of grip sensor 202. The other side of resistor R19 and the other side of resistor R20 are connected to the ground.

The port 7 of grip sensor 202 is connected to one side of switch S4, one side of potentiometer W4, one side of resistor R13, one side of resistor R21, and one side of resistor R22. The other side of switch S4, the other side of potentiometer W4, and the other side of resistor R13 are connected to the port 8 of grip sensor 202. The other side of resistor R21 and the other side of resistor R22 are connected to the ground.

The port 9 of grip sensor 202 is connected to one side of switch S5, one side of potentiometer W5, one side of resistor R14, one side of resistor R23, and one side of resistor R24. The other side of switch S5, the other side of potentiometer W5, and the other side of resistor R14 are connected to the port 10 of grip sensor 202. The other side of resistor R23 and the other side of resistor R24 are connected to the ground.

The model number for the sound module 206 in this embodiment is GPC11512C. The pin 18, pin 19, pin 20, and pin 21 of the sound module 206 are connected to pin 40, pin 2, pin 3, and pin 37 of remote control MCU 201 respectively.

This embodiment of the main console module 100 includes the main console MCU 101. The main console MCU 101 is connected to the audio and video (A/V) processor module 103. The external video/audio source for the audio processor module 103 can be a TV or PC display, etc. By changing the interface port between the main console MCU 101 and the A/V processor 103 and match with the game software, they can be used with the video game.

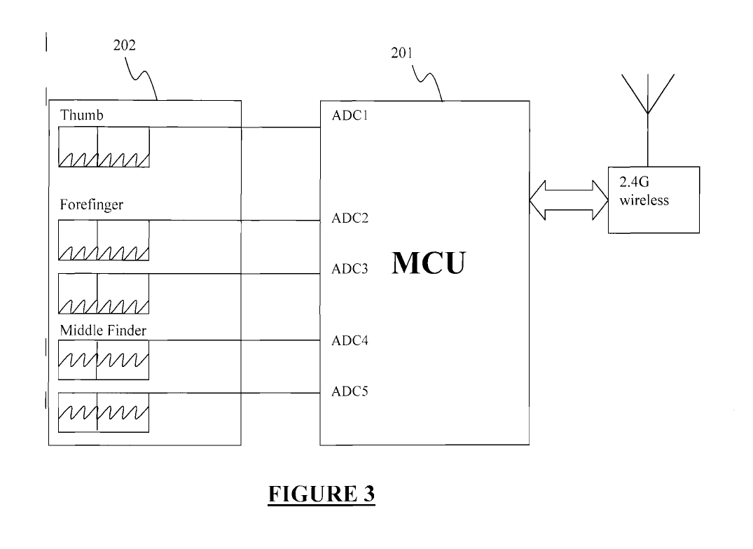

As depicted in FIG. 3, there is a 2×2 analog keys array in a remote control module 200 to detect the gripping force of the front finger and middle finger of a user. There is spongy material on these keys. The pressing force of the thumb of a user is detected by another analog key. Grip sensor 202 will output different DC voltage values according to the gripping forces. The largest value will be used. This information will be transmitted from the remote control module 200 to the main console module 100 by the 2.4 GHz RF wireless transmission technology. The data is sent to the main console MCU 101. The main console MCU 101 will provide feedback based on the detected DC voltage value from the grip sensor 202.

There is a position indicator 204 in the remote control module 200. There is position sensor 104 in the main console module 100. The position indicator 204 provides the position information to the position sensor 104 by the wide angle infrared ray.

There is a sub-MCU 102 in the main console module 100. The sub-MCU 102 is connected to the main console MCU 101. The sub-MCU 102 is connected with the main console wireless transmission module 106. The sub-MCU 102 is connected with the position sensor 104. The sub-MCU 102 will carry out pre-processing of the information transmitted from the remote control module 200 and the position sensor 104, and then send this to the main console MCU 101. This two-step MCU design of the main console module 100 can improve the speed of the video game. Of course, one can also use only one MCU 101 to get the same result.

The model number of the MCU 201 in an embodiment of the remote control module is STM8S. The module number of the MCU 101 in an embodiment of the main console module is GPL32300A.

Embodiment 2: The difference between this embodiment 2 and embodiment 1 is: there are multiple infrared LED emitters in the remote control module. The LED emitters can emit infrared rays. There is an infrared camera in the main console module which can detect the infrared rays from the remote control module. This camera may detect the infrared ray from 0.5-0.6 meters from the infrared source, with the range depending on the intensity of the infrared ray. The viewing angle may be 40 degrees from horizontal or ˜20 degrees from left and right, 30 degrees from vertical or 15 degrees from up and down.

There is an infrared camera in the main console module. It can detect the infrared ray from the infrared LED emitter in the remote control module if it is placed inside the detectable range and thus detect the position of the remote control module. The position sensor 104 detects the infrared ray and gets the coordinates of the remote control module. There is a 3-axis G-sensor inside the remote control module to detect the following 5-axis movement: X axis left/right direction, acceleration; Y axis front/back direction acceleration; Z axis up/down direction acceleration; Y axis as the rotation axis; left/right rotational movement on X axis; X axis as the rotation axis; up/down rotational movement on Y axis. This data will be transmitted to the main console MCU 101 from the remote control module MCU 201 by the 2.4 GHz RF wireless communication technology. The main console MCU 101 will analyze this data and provide feedback.

Embodiment 3: This embodiment is different from embodiment 2 as there is a motion sensor 203 in the remote control module. The motion sensor 203 is connected to the remote control MCU 201. The motion sensor 203 detects the motion of the video game player. The remote control MCU 201 will convert the signal from motion sensor 203 to different messages, and then transmit the messages to the main console module. The main console module will provide feedback accordingly.

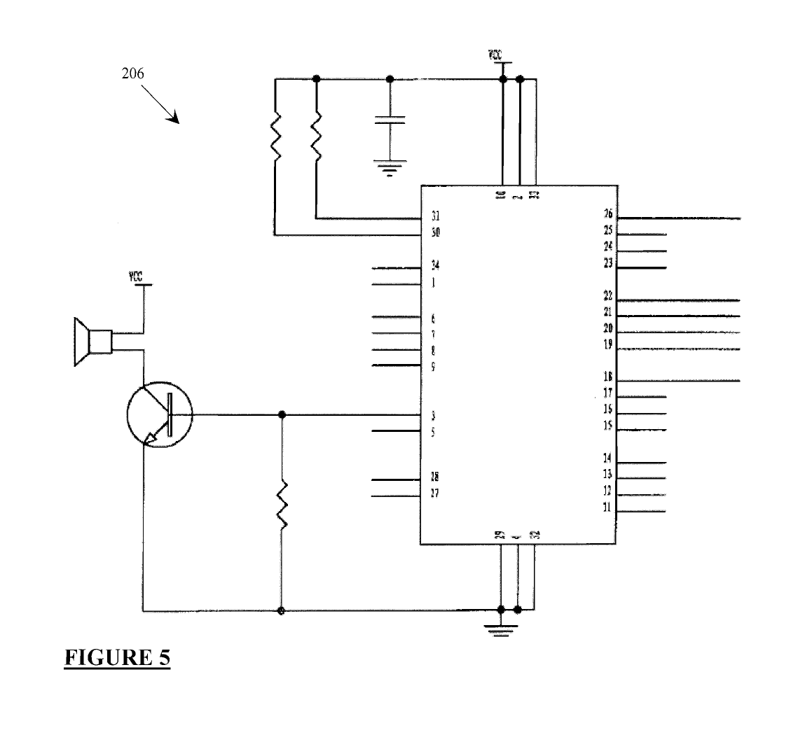

As depicted in FIGS. 4 and 5, the motion sensor 203, the position sensor 204, voice sensor 205, and LED indicator 207 are common circuits known in the art, and there will be no detailed description.

There is a sub-MCU 102 in this embodiment which is connected to the main console MCU 101 by UART or SPI.

There is a storage module 105 in the main console module 100 in this embodiment. The storage module 105 is connected to the main console MCU 101. The storage module 105 is an example of a built-in device or there is a interface on it, e.g. USB socket, SD card socket, so that it can be connected to the U-drive, hard disk, SD Card, external storage device to upgrade the game content.

Finally, it should be noted that the above embodiment descriptions of the invention are included only to illustrate examples of the invention, rather than to limit the scope of protection of the present invention. Although a detailed description is provided, those of skill in the art will understand that various modifications to these embodiments may be made without departing from the essence and scope of this invention.

What is claimed is:

1. A video game action detecting system for use by a game player, comprising:
a main console module comprising a main console wireless communication module,
a remote control module, comprising a remote control MCU, a gripping force detector, and a remote control wireless communication module, wherein the gripping force detector is connected with the remote control MCU, wherein the gripping force detector detects the gripping force of the game player, the gripping force detector provides gripping force information to the remote control MCU, wherein the remote control MCU provides the gripping force information to the remote control wireless communication module, and the remote control wireless communication module transmits the gripping force information to the main console module via the main console wireless communication module.

2. The video game detecting system of claim 1, wherein the gripping force detector comprises port 1, port 2, port 3, port 4, port 5, port 6, port 7, port 8, port 9, and port 10, wherein the remote control MCU comprises MCU pin 20, MCU pin 21, MCU pin 22, MCU pin 23, MCU pin 24, MCU pin 34, MCU pin 35, and MCU pin 47, and wherein MCU pin 20, MCU pin 21, MCU pin 22, MCU pin 23, and MCU pin 24 are connected to port 1, port 3, port 5, port 7, port 9 respectively, and wherein port 2, port 4, port 6, port 8, and port 10 are connected to MCU pin 35;
and wherein the wireless communication module comprises wireless module pin 3, wireless module pin 4, wireless module pin 5, and wireless module pin 6, and wherein the MCU pin 34 is connected to the wireless module pin 3, the MCU pin 47 is connected to the wireless module pin 4, the MCU pin 33 is connected to the wireless module pin 5, the MCU pin 30 is connected to the wireless module pin 6, and the MCU pin 12 is connected to the wireless module pin 8.

3. The video game detecting system of claim 2, wherein the gripping force detector further comprises switches S1 through S5, potentiometers W1 through W5, and resistors R10 through R24;
wherein port 1 of the gripping force detector is connected to one side of switch S1, to one side of potentiometer W1, to one side of resistor R10, to one side of resistor R15, and to one side of resistor R16, and wherein port 2 of the gripping force detector is connected to another side of switch S1, another side of potentiometer W1, and another side of resistor R10, and wherein another side of resistor R16 and another side of resistor R15 are connected to a ground;
wherein port 3 of the gripping force detector is connected to one side of switch S2, to one side of the potentiometer W2, to one side of resistor R11, to one side of resistor R17, and to one side of resistor R18, and wherein port 4 of the gripping force detector is connected to another side of switch S2, another side of potentiometer W2, and another side of resistor R11, and wherein another side of resistor R17 and another side of resistor R18 are connected to the ground;
wherein port 5 of the gripping force detector is connected to one side of switch S3, to one side of the potentiometer W3, to one side of resistor R12, to one side of resistor R19, and to one side of resistor R20, and wherein port 6 of the gripping force detector is connected to another side of switch S3, another side of potentiometer W3, and another side of resistor R12, and wherein another side of resistor R19 and another side of resistor R20 are connected to the ground;
wherein port 7 of the gripping force detector is connected to one side of switch S4, to one side of the potentiometer W4, to one side of resistor R13, to one side of resistor R21, and to one side of resistor R22, and wherein port 8 of the gripping force detector is connected to another side of switch S4, to another side of potentiometer W4, and to another side of resistor R13, and wherein another side of resistor R21 and another side of resistor R22 are connected to the ground;
wherein port 9 of the gripping force detector is connected to one side of switch S5, to one side of the potentiometer W5, to one side of resistor R14, to one side of resistor R23, and to one side of resistor R24, and wherein port 10 of the gripping force detector is connected to another side of switch S5, another side of potentiometer W5, another side of resistor R14, and wherein another side of resistor R23 and another side of resistor R24 are connected to the ground.

4. The video game detecting system of claim 3, wherein the wireless communication module is a 2.4 GHz RF module of model number CB2100.

5. The video game detecting system of claim 4, wherein the remote controller module further comprises a position indicator, and wherein the main console module further comprises a position detector module comprising a wide angle infrared module, and wherein the position detector module determines position information from the position indicator using the wide angle infrared module.

6. The video game detecting system of claim 5, wherein the remote control module further comprises a motion sensor connected to the remote control MCU, and wherein the motion sensor detects motion of the game player, the motion sensor provides detected motion information to the remote control MCU, the remote control MCU transmits the detected motion information to the main console module via the remote control wireless communication module, and the main console module provides feedback based on the detected motion information.

7. The video game detecting system of claim 6, wherein the main console module comprises a main console MCU, and wherein the main console MCU is connected to a video/audio player.

8. The video game detecting system of claim 7, wherein the MCU model number for the remote control MCU is STM8S105, the wherein the MCU model number for the main console MCU is CPL32300A.

9. The video game detecting system of claim 8, wherein the remote control module comprises a sound module, a LED indicator, and a voice sensor, and wherein the voice sensor, LED indicator, and sound module are connected to the remote control MCU,
wherein the voice sensor is configured to detect sound from the game player, and wherein the remote control MCU will convert the sound from the game player to an electric signal and then transmit the electric signal to the main console module,
wherein the LED indicator is configured to provide feedback reaction from the main console module, and the LED indicator is further configured to provide indication of a power on/off status of the remote control module and to provide indication of a status of a wireless connection between the remote control module and the main console module,
and wherein the sound module is configured to playback sound based on the reaction main console module feedback.

10. The video game detecting system of claim 5, wherein the main console module further comprises a main console sub-MCU, a connection between the main console MCU and main console sub-MCU, a connection between the position detector and main console sub-MCU, and a connection between the wireless communication module and main console sub-MCU, and wherein the main console sub-MCU is configured to carry out pre-processing on the position detector signal and the wireless communication module signal and then to provide resulting pre-processed information to the main console MCU.
